(19) United States
(12) Patent Application Publication
(10) Pub. No.: US 2012/0061437 A1
(43) Pub. Date: Mar. 15, 2012

(54) CONDIMENT HOLDING APPARATUS AND METHOD

(76) Inventors: Carter W. McGuyer, Tuscumbia, AL (US); Hollee Candlish, Murfreesboro, TN (US)

(21) Appl. No.: 13/225,313

(22) Filed: Sep. 2, 2011

Related U.S. Application Data
(60) Provisional application No. 61/379,618, filed on Sep. 2, 2010.

(51) Int. Cl. B60R 7/00

(52) U.S. Cl. 224/539

(57) ABSTRACT

The present disclosure describes a product holding apparatus that has a body with at least one receptacle arranged and configured for receiving a product, the body having at least two walls. The product holding apparatus further has a first extension of at least one of the walls arranged for resting upon an outer surface of top of a vehicle door and a second extension of another of the walls arranged for insertion into a slot formed within the vehicle door.

### CROSS-REFERENCE TO RELATED APPLICATION

This application claims priority to U.S. Provisional Patent Application Ser. No. 61/379,618, entitled “Condiment Holding Apparatus and Method,” and filed on Sep. 2, 2010, herein incorporated by reference in its entirety.

### BACKGROUND AND SUMMARY

Sometimes, one will order food to go from a restaurant. In some circumstances, the food ordered comes with products, for example, barbeque sauce, ketchup, or baby carrots. Oftentimes, the food ordered will be eaten in a vehicle. In such a situation, it is difficult to use open baggies of products with the food.

An exemplary product holding apparatus in accordance with an embodiment of the present disclosure comprises a body comprising at least one receptacle arranged and configured for receiving a product, the body comprising at least four outer walls. In addition, the product holding apparatus comprises a first extension of at least one of the four outer walls arranged for resting upon a vehicle door and a second extension of another of the four outer walls arranged for insertion into a slot formed within the vehicle door.

Another exemplary product holding apparatus in accordance with an embodiment of the present disclosure comprises a body comprising at least one receptacle arranged and configured for receiving a product, the body comprising at least four outer walls. In addition, the product holding apparatus comprises a first extension of at least one of the four outer walls arranged for insertion into a cup holder of a console of a vehicle.

A method in accordance with an embodiment of the present disclosure comprises inserting a first extension of a first wall of a first side of a rectangular body into a slot between a vehicle door and a window of the vehicle and resting a second extension of a second wall of a second side of the rectangular body on the vehicle door. The method further comprises inserting at least one product into one or more receptacles formed in the rectangular body.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the figures.

FIG. 1 is a perspective view of a product holding apparatus in accordance with an exemplary embodiment of the present disclosure.

FIG. 2 is a cross-sectional view of the product holding apparatus, such as is depicted in FIG. 1.

FIG. 3 is a perspective view of the product holding apparatus, such as is depicted in FIG. 1, showing in a different orientation with respect to a car door and corresponding window.

FIG. 4 is a cross-sectional view of the product holding apparatus oriented as depicted in FIG. 3.

FIG. 5 is a top plan view of the product holding apparatus, such as is depicted of FIG. 1.

FIG. 6 is a perspective view of another embodiment of the product holding apparatus, such as is depicted of FIG. 1

FIG. 7 is a perspective view of another side of the product holding apparatus, such as is depicted in FIG. 6.

FIG. 8 is a side plan view of the product holding apparatus, such as is depicted in FIG. 1.

FIG. 9 is a perspective view of the product holding apparatus of FIG. 6 showing the product holding apparatus being inserted into a cup holder of a vehicle console.

FIG. 10 is a perspective view of an exemplary product holding apparatus in accordance with another embodiment of the present disclosure, showing the product holding apparatus having a suction cup for further affixing the product holding apparatus to a vehicle.

FIG. 11 is a flowchart depicting an exemplary method in accordance with an embodiment of the present disclosure.

FIG. 12 is a perspective view of another exemplary product holding apparatus having a packet emptying slot in accordance with another embodiment of the present disclosure.

FIG. 13 is a side view of the product holding apparatus, such as is depicted in FIG. 12.

FIG. 14 is a perspective view of the product holding apparatus, such as is depicted in FIG. 12, showing a product packet's interface with the apparatus.

FIG. 15 is a perspective view of another exemplary embodiment of a product apparatus in accordance with an embodiment of the present disclosure showing a packet emptying slot oriented on a side of the apparatus.

### DETAILED DESCRIPTION OF THE INVENTION

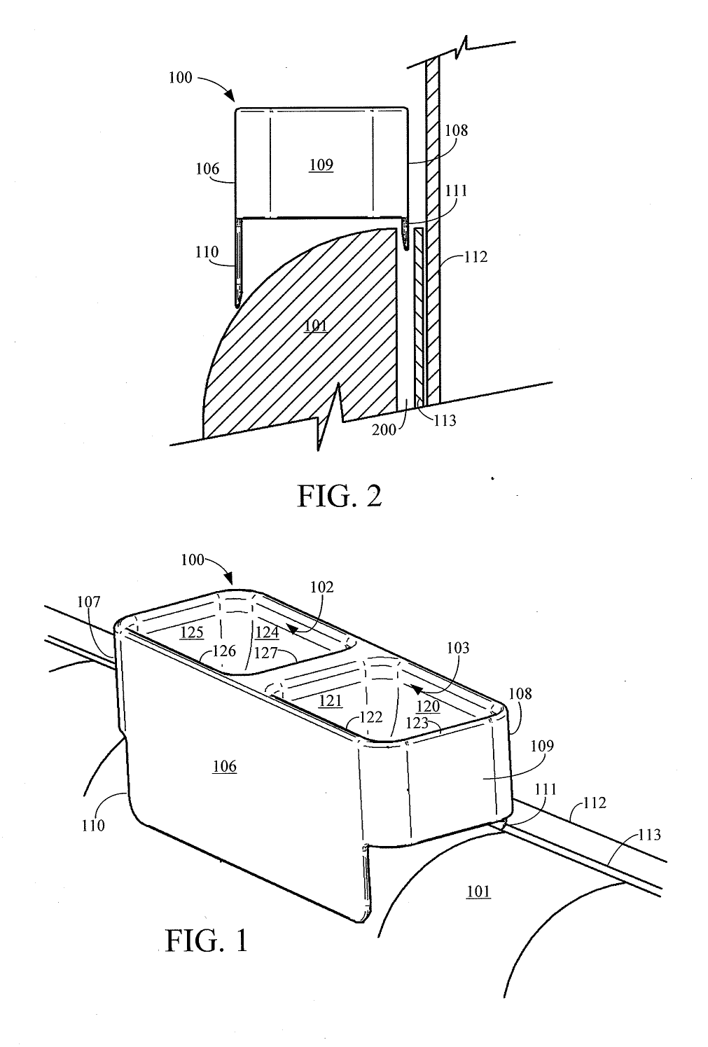

FIG. 1 is a perspective view of a product holding apparatus 100 in accordance with an embodiment of the present disclosure. The product holding apparatus 100 rests on top of a vehicle door 101.

The product holding apparatus comprises four contiguous outer walls 106-109 that form a substantially rectangular body. Formed within the top of the rectangular body is a pair of receptacles 102, 103. In one exemplary embodiment, the receptacles 102, 103 each comprise four inner walls 120-123 and 124-127, respectively.

Note that four inner walls are shown for exemplary purposes. The receptacles 102, 103 may have fewer or additional walls in other embodiments. For example, the receptacles 102, 103 may have three inner walls and five inner walls, respectively.

Further note that one or more of the four inner walls may be tapered in another embodiment. In this regard, one or more tapering inner walls may aid in filling or retaining products in the receptacles.

Wall 106 comprises an extension 110 that extends beneath the rectangular body formed by the contiguous outer walls 106-109. In addition, wall 108 comprises an extension 111 (further shown in FIG. 2) that extends beneath the rectangular body formed by the contiguous walls 106-109. The extension 110 rests upon an outer surface of the vehicle door 101, while the extension 111 fits within a slit formed between a window 112 and a window seal 113 and the door 101.

During use, the product holding apparatus 100 is placed on the door 101 such that the extension 110 rests on the door. In addition, the extension 111 is inserted between the window 112, the window seal 113 and the door 101. Products (not shown) may then be placed within the receptacles 102 and 103 (FIG. 1) contacting and being retained by the inner walls 120-123 and 124-127 thereby making the products easier to access by a user within a vehicle (not shown). In addition, the product holding apparatus 100 secures the products so that they do not spill.

FIG. 2 depicts a cross-sectional view of the product holding apparatus 100 depicted in FIG. 1. Notably, the product holding apparatus 100 comprises the wall 106 that has the extension 110. The extension 110 rests upon the vehicle door 101. In the embodiment, the extension 111 of the wall 108 is somewhat shorter than the extension 110. The somewhat shortened extension 111 fits within a slot 200 formed between the window 112, the window seal 113 and the door 101. The extensions 110, 111 level and position the product holder 100 so that products (not shown) can be placed in the receptacles 102 (FIGS. 1) and 103 (FIG. 1), which mitigates the risk that the products will be spilled.

Note that FIG. 2 shows the wall extension 111 being inserted into the slot 200 that is formed between the vehicle door 101 and the window seal 113. However, it is possible in other embodiments for the extension 111 to be inserted differently. For example, the extension 111 may be inserted between the window seal 113 and the window 112.

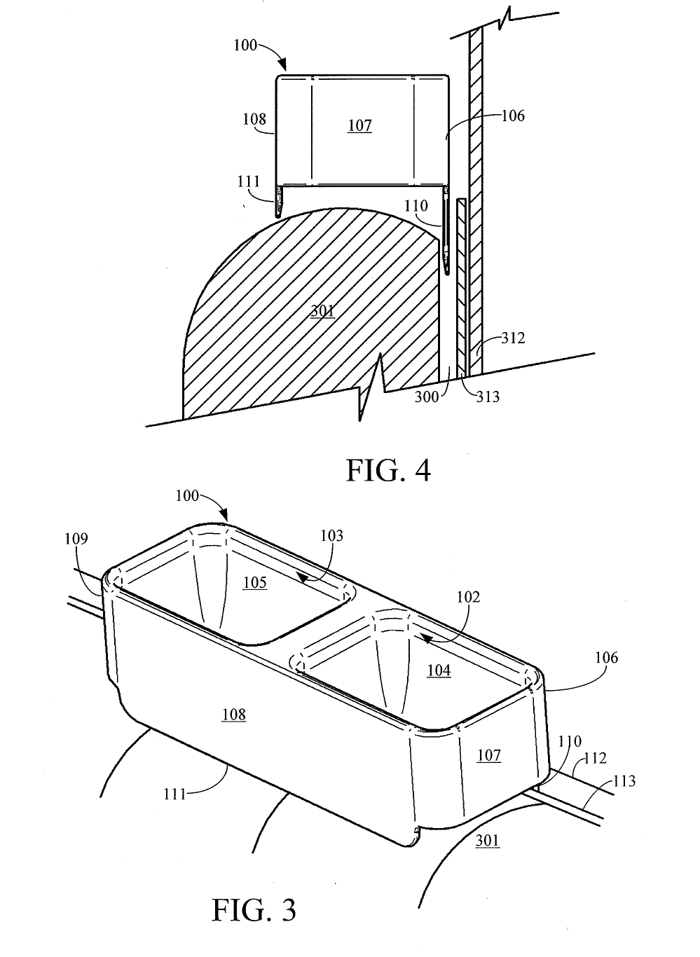

FIG. 3 is a perspective view of the product holding apparatus 100 showing the product apparatus 100 in a different orientation other than that shown with reference to FIGS. 1, 2. In this regard, the product apparatus 100 comprises the four contiguous walls 106-109 that form the substantially rectangular body. The product apparatus 100 comprises the receptacles 102, 103 having tapered walls 104, 105, respectively, for receiving products.

However, in FIG. 3, the product holding apparatus 100 is oriented differently that that shown in FIG. 1. In this regard, the shorter extension 111 that extends from the wall 108 rests upon the vehicle door 301, which is shaped differently than the vehicle door 101 depicted in FIG. 1. In addition, the longer extension 110 is inserted between the window 112, the window seal 113, and the vehicle door 301.

Such orientation is shown in more detail with reference to a cross-sectional view of the product holding apparatus 100, which is depicted in FIG. 4. Notably, the product holding apparatus 100 comprises the wall 108 that has the extension 111. The extension 111 rests upon the vehicle door 301. Note that the vehicle door 301 has a larger radius of curvature than the vehicle door 101 depicted in FIG. 1.

In such an orientation, the somewhat longer extension 110 of the wall 106 fits within the slot 300 formed between the window 312, the window seal 313 and the door 301. The extensions 110, 111 level and position the product holder 100 so that products (not shown) can be placed in the receptacles 102 (FIGS. 3) and 103 (FIG. 3), which mitigates the risk that the products will be spilled.

Note that FIG. 4 shows the wall extension 110 being inserted into the slot 300 that is formed between the vehicle door 301 and the window seal 313. However, it is possible in other embodiments for the extension 110 to be inserted differently. For example, the extension 110 may be inserted between the window seal 313 and the window 312.

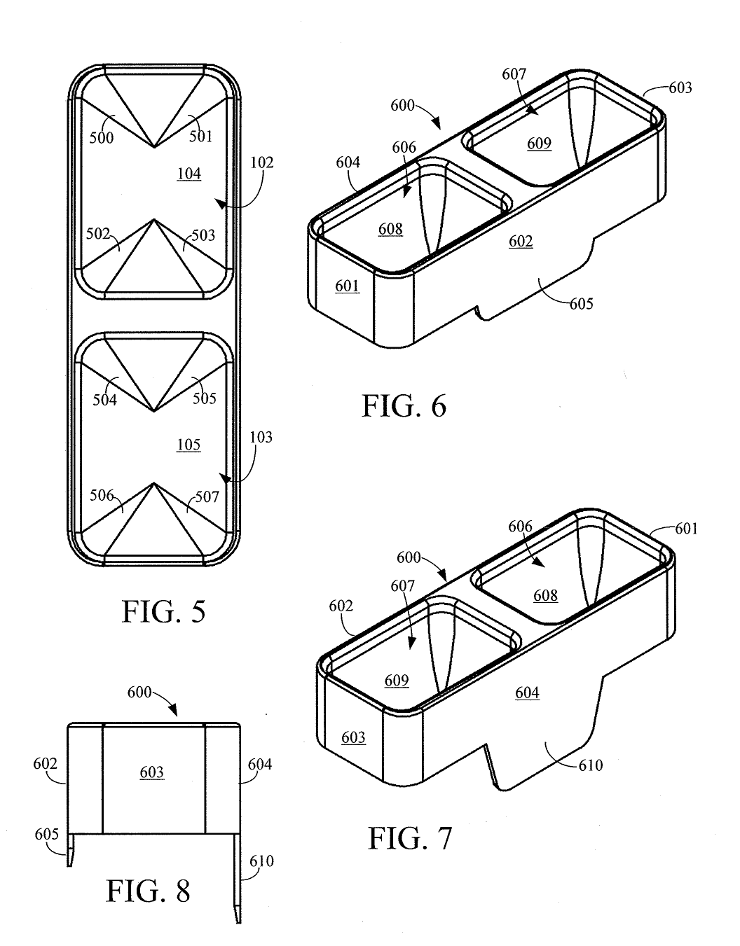

FIG. 5 depicts a top plan view of the product holding apparatus 100 described hereinabove. In particular, FIG. 5 depicts in more detail the receptacles 102, 103. As described hereinabove, the receptacles 102, 103 comprise tapering inner walls 104, 105, respectively.

In addition, the corners 500-503, 504-507 of the tapering inner walls 104, 105, respectively, are rounded, so that products (not shown) can be easily inserted and retained by the inner walls 104, 105. In this regard, the rounded corners 500-503, 504-507 exert a force that is inward to the receptacles 102, 103, such force is applied to the products, which retains them within the receptacles 102, 103.

FIG. 6 is a perspective view of another product holding apparatus 600 in accordance with another embodiment of the present disclosure. Similar to the product apparatus 100 (FIGS. 1, 2), the product holding apparatus 600 comprises outer walls 601-604 that form a substantially rectangular body. Within the top of the rectangular body formed by the outer walls 601-604 are receptacles 606, 607. Receptacles 606, 607 are substantially rectangular and comprise inner tapering walls 608, 609, respectively.

The outer wall 602 of the product holding apparatus 600 comprises an extension 605. The extension 605 does not extend from one corner of the rectangular body to another corner. Instead, the extension 605 only expands a portion of the width of the outer wall 602.

FIG. 7 depicts a perspective view of the opposing side of the product holding apparatus 600 depicted in FIG. 6. In such an embodiment, the outer wall 604 comprises an extension 610. The extension 610 extends somewhat longer from the wall 604 and does not extend from one corner of the rectangular body to another. Instead, the extension 610 only expands a portion of the width of the outer wall 604.

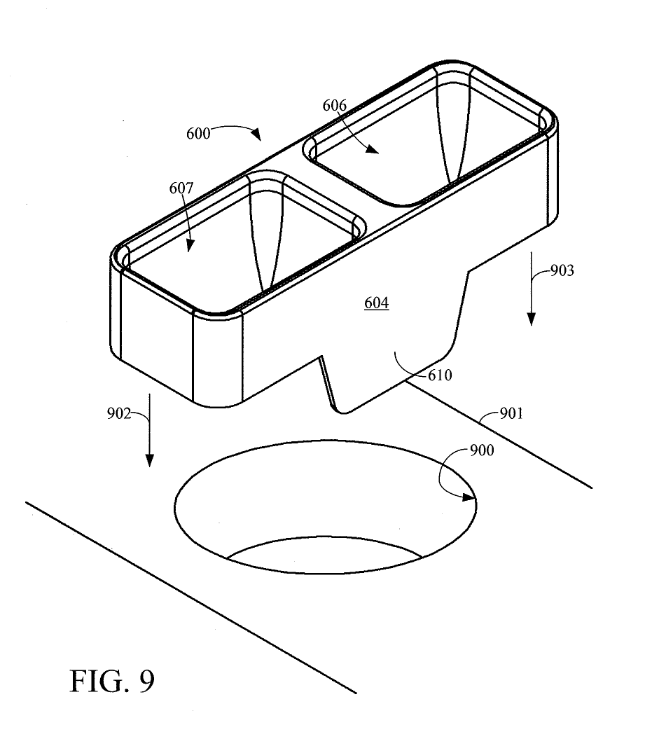

FIG. 8 depicts a side view of the product holding apparatus 600. Notably, the wall 602 comprises the extension 605. In addition, the wall 604 comprises the extension 610. Notably, the wall extension 605 is somewhat shorter than the wall extension 610.

FIG. 9 depicts the product holding apparatus 600 in use. In this regard, the product holding apparatus 600 may be inserted into a cup holder 900 of a console 901. When in use, the product holding apparatus 600 is inserted as indicated by reference arrows 902, 903 into the cup holder 900.

When inserted, the extension 610 of the wall 604 fits within the cup holder 900 thereby retaining, leveling and/or positioning the product holding apparatus 600 so that products (not shown) can be placed within the receptacles 606, 607 in such a manner as to mitigate spilling and for ease of use of the products.

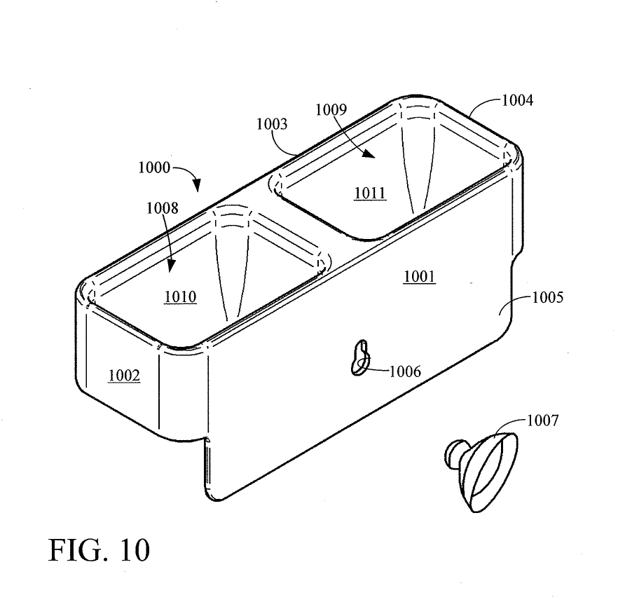

FIG. 10 depicts another product holding apparatus 1000 in accordance with another embodiment of the present disclosure. In such an embodiment, the product holding apparatus 1000 comprises four contiguous walls 1001-1004 that form a substantially rectangular body. Similar to the product holding apparatuses 100, 600, the product holding apparatus 1000 comprises the receptacles 1008, 1009 having tapered walls 1010, 1011, respectively, for receiving products.

In addition, similar to the product holding apparatus 100, the wall 1001 has a wall extension 1005 that extends from each corner of the rectangular body. Within the wall 1001 and/or the wall extension 1006 is an opening 1006. In one embodiment, the opening 1006 is a keyhole opening.

The opening receives and retains a suction cup 1007. During use, the suction cup 1007 may be coupled to a portion of the vehicle (not shown) on which the product holding apparatus 1000 is being used. In one embodiment, the suction cup 1007 may be coupled to a window (not shown) of the vehicle to further secure the product holding apparatus 1000 in position for use.

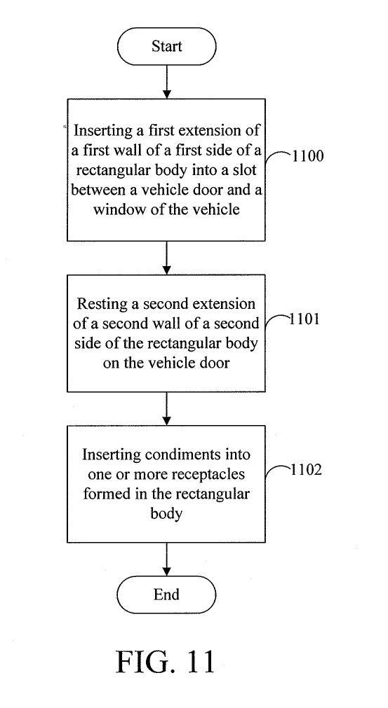

FIG. 11 depicts an exemplary method in accordance with an embodiment of the present disclosure. The first step 1100 is inserting a first extension 111 (FIG. 1) of a first wall 108 (FIG. 1) of a first side of a rectangular body into a slot 200 (FIG. 2) between a vehicle door 101 (FIG. 2) and a window 112 (FIG. 2) of the vehicle (not shown). As described hereinabove, insertion may be made between the vehicle door 101 and a window seal 113 (FIG. 2), between the window seal 113 and the window 112, or where no window seal 113 is present, between the vehicle door 101 and the window 112.

The next step 1101 is resting a second extension 110 (FIG. 1) of a second wall 106 (FIG. 1) of a second side of the rectangular body on the vehicle door 101 (FIG. 1). The last step 1102 is inserting products (not shown) into one or more receptacles 120, 103 (FIG. 1) formed in the rectangular body.

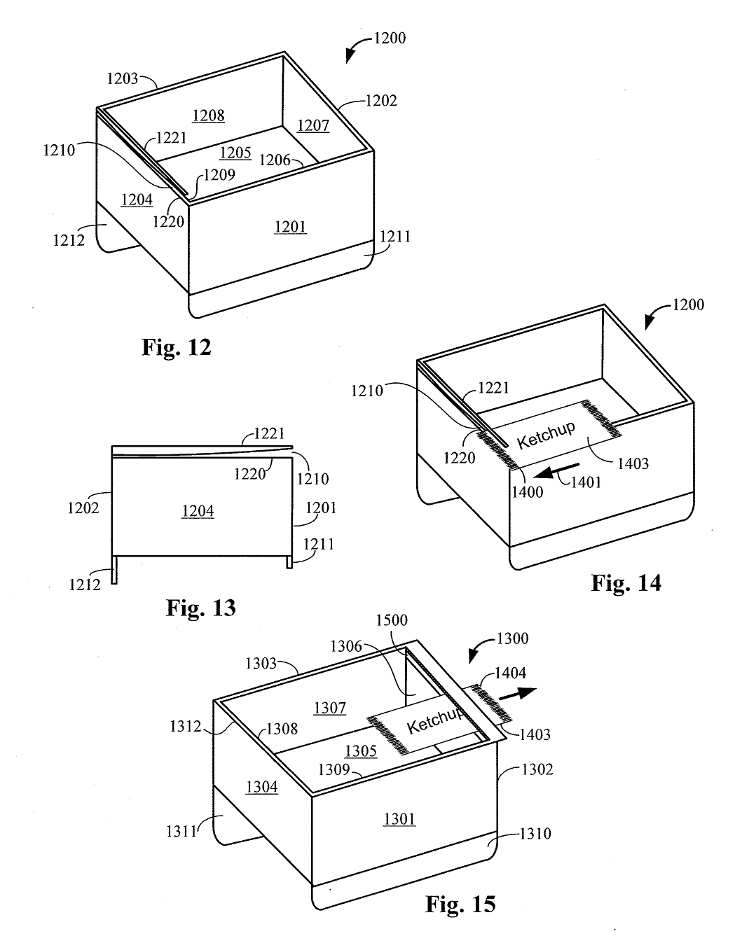

FIG. 12 is a perspective view of a product holding apparatus 1200 in accordance with another embodiment of the present disclosure. The product holding apparatus 1200, similar to the product holding apparatus 100 (FIG. 1), rests on top of a vehicle door (not shown), similarly to the product holding apparatus 100 resting on the vehicle door 101 in FIG. 1.

The product holding apparatus 1200 comprises four contiguous outer walls 1201-1204 that form a substantially rectangular body. Formed within the top of the rectangular body is at least one receptacle 1205. The receptacle 1205 comprises four inner walls 1206-1209.

Note that four inner walls are shown for exemplary purposes. The receptacle 1205 may have fewer or additional walls in other embodiments. For example, the receptacle 1205 may have three inner walls.

Note that in one embodiment, one or more of the inner walls 1206-1209 may be tapered. In this regard, tapered inner walls (whether one or more) may aid in filling a retaining a product, e.g., a condiment, within the receptacle 1205.

Wall 1203 comprises an extension 1212 that extends beneath the rectangular body formed by the contiguous outer walls 1201-1204. In addition, wall 1201 comprises an extension 1211 that extends beneath the rectangular body formed by the contiguous walls 1201-1204. The extension 1212 rests upon a vehicle door (similar to the vehicle door 101 in FIG. 1), while the extension 1211 fits within a slit formed between a window and a window seal and a door (similar to the window 112, the window seal 113, and the door 101 shown in FIG. 1).

The product holding apparatus 1200 further comprises a slit 1210. The slit 1210 is formed by a top 1220 of the outer side wall 1204 and an arm 1221 that extends from the inner wall 1208. The top 1220 of the outer side wall 1204 and the arm 1221 are separated one from another forming the slit 1210.

During use, the product holding apparatus 1200 is placed on the door such that the extension 1212 rests on the door. In addition, the extension 1211 is inserted between the window, the window seal and the door. Products, e.g., condiments (not shown), may then be placed within the receptacle 1205 filling and being retained by the inner walls 1206-1209, thereby making the products easier to access by a user within a vehicle (not shown). In addition, the product holding apparatus 1200 secures the products so that they do not spill.

Furthermore, if a user of the product holding apparatus 1200 desires to fill the receptacle 1205 with a condiment contained within a packet (not shown), the user can used the slit 1210 to empty the condiment contained in the packet into the receptacle 1205 by sliding the packet through the slit 1210, which is shown in FIG. 14.

FIG. 13 is a side view of the product holding apparatus 1200 depicted in FIG. 12. The side view shows the outer side wall 1204. The extensions 1211 and 1212 extend from the outer side walls 1201 and 1203, respectively.

Further, the top 1220 of the outer side wall 1204 and the arm 1221 form the slit 1210. In FIG. 12, the slip 1210 is shown as initiating from the outer side wall 1203 and extending along the top 1220 of the outer side wall 120r. In the embodiment shown, the slit 1210 begins at a particular width and increases in width as the arm extends further along to the outer side wall 1202. Such width increase aids in squeezing a packet that is pulled through the slit 1210.

FIG. 14 depicts the product holding apparatus 1200 comprising the slit 1210. As shown, a user grasps an end of a packet 1403, e.g., end 1400, and inserts the end 1400 through the slit 1210 from the inside of the receptacle 1205. The user then pulls the end 1400 in a direction indicated direction arrow 1401. As the packet 1403 moves through the slit 1210, the arm 1221 and the top 1220 of the outer side wall squeeze the packet, which causes pressure on the condiment (not shown) within the packet 1403 so that the condiment squeezes out into the receptacle 1205.

FIG. 15 is a perspective view of a product holding apparatus 1300 in accordance with another embodiment of the present disclosure. The product holding apparatus 1300, similar to the product holding apparatus 100 (FIG. 1), rests on top of a vehicle door (not shown), similarly to the product holding apparatus 100 resting on the vehicle door 101 in FIG. 1.

The product holding apparatus 1300 comprises four contiguous outer walls 1301-1304 that form a substantially rectangular body. Formed within the top of the rectangular body is at least one receptacle 1305. The receptacle 1305 comprises four inner walls 1306-1309.

Note that four inner walls are shown for exemplary purposes. The receptacle 1305 may have fewer or additional walls in other embodiments. For example, the receptacle 1305 may have three inner walls or five inner walls.

Note that in one embodiment, the one or more of the inner walls 1306-1309 may be tapered. In this regard, tapered inner walls (whether one or more) may aid in filling a retaining a product, e.g., a condiment, within the receptacle 1305.

Wall 1303 comprises an extension 1311 that extends beneath the rectangular body formed by the contiguous outer walls 1301-1304. In addition, wall 1301 comprises an extension 1310 that extends beneath the rectangular body formed by the contiguous walls 1301-1304. The extension 1311 rests upon a vehicle door (similar to the vehicle door 101 in FIG. 1), while the extension 1310 fits within a slit formed between a window and a window seal and a door (similar to the window 112, the window seal 113, and the door 101 shown in FIG. 1).

The product holding apparatus 1300 further comprises a slit 1500. The slit 1500 is formed by an opening in the outer side wall 1302 and the inner side wall 1306.

During use, the product holding apparatus 1500 is placed on the door such that the extension 1310 rests on the door. In addition, the extension 1311 is inserted between the window, the window seal and the door. Products, e.g., condiments (not shown), may then be placed within the receptacle 1305 filling and being retained by the inner walls 1306-1309, thereby making the products easier to access by a user within a vehicle (not shown). In addition, the product holding apparatus 1300 secures the products so that they do not spill.

Furthermore, if a user of the product holding apparatus 1200 desires to fill the receptacle 1305 with a condiment contained within a packet (not shown), the user can use the slit 1500 to empty the condiment contained in the packet into the receptacle 1305 by sliding the packet 1403 through the slit 1500, which is shown in FIG. 14. As shown in FIG. 14, the user only need to grasp the end 1404 of the packet as it is sliding through the slit 1500 when a portion of the packet 1403 is on the inside.

1. A product holding apparatus, comprising:
a body comprising at least one receptacle arranged and configured for receiving a product, the body comprising at least two walls;
a first extension of at least one of the walls arranged for resting upon an outer surface of top of a vehicle door; and
a second extension of another of the walls arranged for insertion into a slot formed within the vehicle door.

2. The product holding apparatus of claim 1, wherein the body is rectangular.

3. The product holding apparatus of claim 1, wherein the at least one receptacle has a tapering inner wall.

4. The product holding apparatus of claim 1, wherein the first extension extends from one corner of the body to another corner of the body.

5. The product holding apparatus of claim 1, wherein the second extension extends from one corner of the body to another corner of the body.

6. The product holding apparatus of claim 1, wherein the extension is substantially longer than the second extension.

7. The product holding apparatus of claim 6, wherein the first extension is substantially long so that the first extension extends down to a top of a door of a vehicle when the second extension is inserted in a vehicle window.

8. The product holding apparatus of claim 1, wherein at least one of the walls comprises a slit through the wall.

9. The product holding apparatus of claim 8, wherein a user inserts a packet of product within the slit and pulls the packet through the slit so that the product empties into the receptacle.

10. The product holding apparatus 1, further comprising a slit extending widthwise along one of the walls.

11. The product holding apparatus 10, wherein a user inserts a packet of product into the slit and pulls the packet through the slit to empty the product contained in the packet into the receptacle.

12. The product holding apparatus of claim 1, wherein the body comprises at least two walls.

13. A product holding method, comprising:
resting a first extension of a first wall of a receptacle body upon an outer surface of top of a vehicle door;
inserting a second extension of a second wall of the receptacle body into a slot formed within a vehicle door; and
maintaining the receptacle in a horizontal position while a user uses product contained in the receptacle.

14. The product holding method of claim 13, further comprising directing the product into the receptacle by a tapering inner wall when the user is placing the product in the receptacle.

15. The product holding method of claim 13, further comprising extending a bottom edge of the first extension down to a top of a door of a vehicle when the second extension is inserted in a slit in a vehicle window.

16. The product holding method of claim 13, further comprising pulling a condiment packet through a slit formed in one of the walls so that the condiment fills the receptacle.

17. A product holding apparatus, comprising:
a body comprising at least one receptacle arranged and configured for receiving a product, the body comprising at least four outer walls;
a first extension of at least one of the four outer walls arranged for insertion into a cup holder of a console of a vehicle.

18. A method, comprising:
inserting a first extension of a first wall of a first side of a rectangular body into a slot between a vehicle door and a window of the vehicle;
resting a second extension of a second wall of a second side of the rectangular body on the vehicle door; and
inserting at least one product into one or more receptacles formed in the rectangular body.
